(19) United States
(12) Patent Application Publication
(10) Pub. No.: US 2021/0332839 A1
(43) Pub. Date: Oct. 28, 2021

(54) MULTIDIRECTIONALLY-ENGAGEABLE COLUMN COMBINATION STRUCTURE

(71) Applicant: Ning-Chih Yang, Tainan (TW)

(72) Inventor: Ning-Chih Yang, Tainan (TW)

(21) Appl. No.: 16/921,762

(22) Filed: Jul. 6, 2020

(30) Foreign Application Priority Data
Apr. 24, 2020 (TW) 109204905

(51) Int. Cl. F16B 12/34; F16B 9/02

(52) U.S. Cl. CPC F16B 12/34; A47C 7/004; F16B 9/02

(57) ABSTRACT

A multi-directionally engageable column combination structure comprising a column, a first hook body, and a second hook body. The column is in a straight cylindrical shape and has an outer circular surface and two end faces. A plurality of axial combination grooves are disposed at the outer circular surface, and the combination groove has an opening, a first catching groove and a second catching groove; a front end of the first hook body has a first hook portion, a rear end of the first hook portion has a first engaging portion, a front end of the first hook portion has a first hook pillar, a first hook edge is disposed at a front end of the first hook pillar, an abutting edge is disposed at a position that is on the first hook portion and corresponds to the outer circular surface of the column; a side of the first engaging portion has a first engaging surface, and a first combination hole is disposed on the first engaging surface; a front end of the second hook body has a second hook portion, a rear end of the second hook portion has a second engaging portion, a front end of the second hook portion has a second hook pillar, a second hook edge is disposed at a front end of the second hook pillar, a side of the second engaging portion has a second engaging surface attached against the first engaging surface, and a second combination hole is disposed, the first and second hook edges of the first and second hook bodies hook the first and second catching grooves respectively, and then engaging elements are inserted into the first and second combination holes for combination. Thus, better assembly convenience and stability are achieved in the present application.

### BACKGROUND OF INVENTION

### 1. Field of Invention

The present application relates to multi-directionally-engageable column combination structures and particularly to a structure with better assembly convenience and stability.

### 2. Description of Related Art

Various products, such as study desk, seat, compartment, shelf, cabinet, and elevated flooring and so on are generally supported with straight columns. These columns may be set in a direction perpendicular, or parallel to the ground or in another direction. Study desk, seat, and other components may be disposed on the columns by using fixing elements.

In order to provide assembly convenience, four or eight T-shaped grooves are arranged on a surface of the column in different directions and a T-shaped hook body is provided at an end of an external component. The T-shaped hook body may be embedded from one end of the column into the T-shaped groove and then moved to an appropriate position in the middle of the column for combination so that the hook body will not separate from the column along a radial direction of the column.

In the preceding assembly manner, it is required to perform assembly from the end of the column, resulting in assembly inconvenience. Further, when a hook body of another external component is present in the middle of the column and hinders assembly of another hook body, it is required to firstly take out the hook body of the external component and then assemble another hook body. Such assembly consumes much time.

Furthermore, at present, a U-shaped groove may be disposed on the column and the end of the external component is directly placed at the groove position of the column and then locked with a bolt. In this way, it is not required to perform insertion combination from the end of the column any more during assembly. However, the above combination manner will easily cause the external component to directly separate along the radial direction of the column when the bolt is loosened.

### SUMMARY OF THE INVENTION

One object of the present application is to provide a column combination structure with better assembly convenience and stability.

The column combination structure includes a column, a first hook body, and a second hook body. The column is in a straight shape and has an outer circular surface and two end faces. A plurality of axial combination grooves inwardly recessed toward a center of the column are provided at different angular positions of the outer circular surface, a spacing portion is provided between adjacent combination grooves, an outer side of the combination groove has an opening corresponding to the radial direction of the column, the opening has opposite first and second side walls, first and second catching grooves along a circumferential direction are disposed at inner sides of the first and second side walls respectively, and the first and second catching grooves are opposite in direction; a front end of the first hook body has a first hook portion, a rear end of the first hook portion has a first engaging portion, a front end of the first hook portion has a first hook pillar that may be inserted into the opening of the combination groove, and a first hook edge that may be embedded into the first catching groove is provided at a front end of the first hook pillar; a side of the first engaging portion has a first engaging surface, and a first combination hole corresponding to a perpendicular direction of the first engaging surface is disposed at the first engaging surface; a front end of the second hook body has a second hook portion, a rear end of the second hook portion has a second engaging portion, a front end of the second hook portion has a second hook pillar that may be inserted into the opening of the combination groove, a second hook edge that may be embedded into the second catching groove is provided at a front end of the second hook pillar, a side of the second engaging portion has a second engaging surface that may be attached against the first engaging surface, a second combination hole corresponding to a perpendicular direction of the second engaging surface is provided at a position corresponding to the first combination hole, the first and second hook edges of the first and second hook bodies may hook the first and second catching grooves respectively and then engaging elements are inserted into the first and second combination holes for combination.

Further, an inwardly concave buffer groove is disposed on the second engaging surface.

Further, an abutting edge abutting against the outer circular surface of the column is provided at a position that is on the first hook portion and corresponds to the outer circular surface, an abutting edge is further disposed at a position that is on the first hook portion and corresponds to the outer circular surface of the column, and the first hook pillar has a first side surface attached against the first side wall of the combination groove; the second hook pillar has a second side surface attached against the second side wall of the combination groove, the column is a cylindrical body, six combination grooves may be provided and adjacent combination grooves may be spaced apart by 60°.

According to the present application, the first hook portion of the first hook body is inserted into the opening of the combination groove at an appropriate angular position of the column so as to enable the first hook edge to hook the first catching groove, and the second hook portion of the second hook body is inserted into the opening of another adjacent combination groove to enable the second hook edge to hook the second catching groove. In this way, the first and second engaging surfaces are attached closely, and engaging elements are inserted into the first and second combination holes of the first and second engaging portions for combination. Further, when the buffer groove of the second engaging portion is provided so that the first and second engaging surfaces may be abutted against each other more stably when the engaging elements are thread-tightened. In this case, the first and second hook edges may respectively hook the first and second catching grooves more stably and clamp the spacing portion of the column. Further, the first and second side surfaces may be closely attached against the first and second side walls respectively, and the abutting edge of the first hook portion can be closely abutted against the outer circular surface of the column, so that the entire combination can have better combination stability without loosening. In the present application, the first and second hook bodies may be directly inserted into appropriate positions of the combination grooves of the column for combination without need of being inserted into the combination grooves from the end face of the column and then moved to the appropriate positions of the combination grooves. Thus, the better assembly convenience can be achieved.

### BRIEF DESCRIPTION OF THE DRAWING

FIG. 1 is an exploded diagram based on an embedment of the present application.

FIG. 2 is a combination sectional diagram of an external component of a combination based on an embedment of the present application.

FIG. 3 is a perspective diagram based on an embedment of a combination of the present application.

FIG. 4 is a stereoscopic exploded diagram of a column of different directions and connection block based on an embedment of the present application.

FIG. 5 is a combination sectional diagram of a column of different directions according to an embodiment of the present application.

FIG. 6 is a schematic diagram of a seat to which the present application is applied based on an embedment of the present application.

### DETAILED DESCRIPTION OF PREFERRED EMBODIMENTS OF THE INVENTION

The following embodiments are provided to illustrate, but not to limit the instant invention.

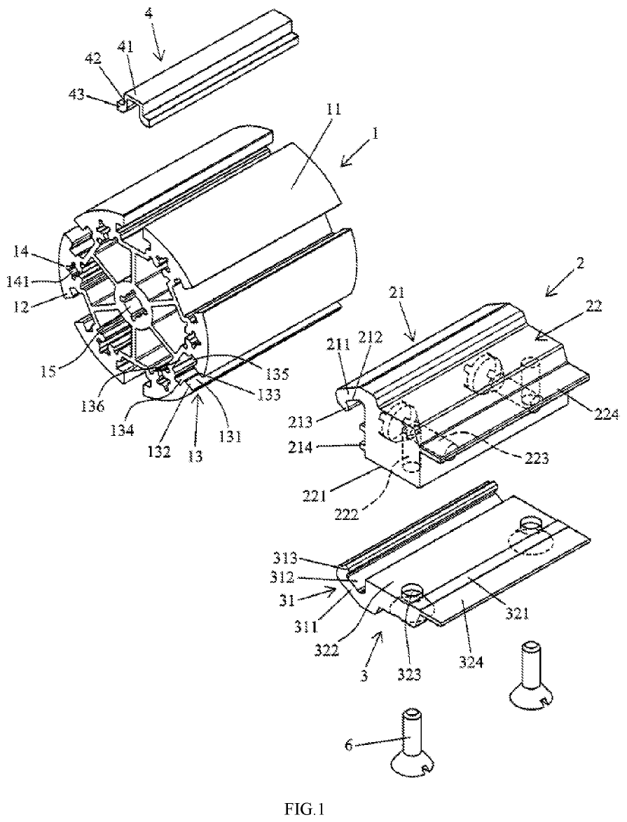

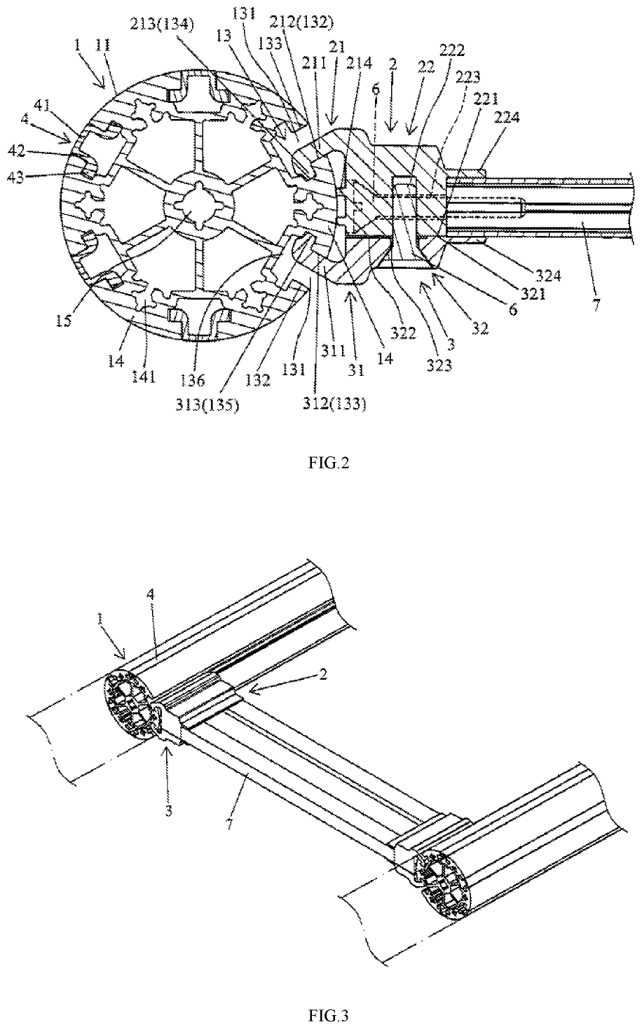

As shown in FIGS. 1-3, a column combination structure based on an embodiment of the present application includes a column 1, a first hook body 2, a second hook body 3 and a plurality of cover frames 4. The column is a straight cylindrical body and has an outer circular surface 1 and two end faces 12, a plurality of axial combination grooves 13 inwardly recessed toward a center of the column are disposed on the outer circular surface 11, a spacing portion 14 is disposed between adjacent combination grooves 13, the number of the combination grooves is six, and adjacent combination grooves 13 are spaced apart by 60°. An outer side of the combination groove has an opening 131 corresponding to a radial direction of the column 1, the opening 131 has a first side wall 132 and a second side wall 133 paralleled to each other, a first catching groove 134 and a second catching groove 135 along a circumferential direction are disposed at respective inner sides of the first side wall 132 and the second side wall 133, the first catching groove 134 and the second catching groove 135 are opposite in direction, and a recess 136 is disposed at an inner position of the first catching groove 134 and the second catching groove 135; an axial combination hole 141 is disposed at the spacing portion 14; and a through hole 15 is provided at the center of the column 1.

A front end of the first hook body 2 has a first hook portion 21, a rear end of the first hook portion 21 has a first engaging portion 22, a front end of the first hook portion 21 has a first hook pillar 211 that may be inserted into the opening 131 of the combination groove 13, the first hook pillar 211 has a first side surface 212 attached against the first side wall 132 of the combination groove 13, a first hook edge 213 that may be embedded into the first catching groove 134 is disposed at a front end of the first hook pillar 211, and a abutting edge 214 is disposed at a position that is on the first hook portion 21 and corresponds to the outer circular surface of the column 1; a side of the first engaging portion 22 has a first engaging surface 221, a first combination hole 222 corresponding to the perpendicular direction of the first engaging surface 221 is disposed at the first engaging surface 221, the first combination hole 222 has thread, an engaging hole 223 corresponding to a back and forth direction and connecting with an external component 7 is disposed (the external component in the embodiment is a sheet-like shape), and a first clamping sheet 224 is disposed at the back of the first engaging portion 22.

A front end of the second hook body 3 has a second hook portion 31, a rear end of the second hook portion 31 has a second engaging portion 32, a front end of the second hook portion 31 has a second hook pillar 311 that may be inserted into the opening 131 of the combination groove 13, the second hook pillar 311 has a second side surface 312 that may be attached against the second side wall 133 of the combination groove 13, a second hook edge 313 that may be embedded into the second catching groove 135 is disposed at a front end of the second hook pillar 311, a side of the second engaging portion 32 has a second engaging surface that may be attached against the first engaging surface 221, a buffer groove 322 is disposed on the second engaging surface 321, a second combination hole 323 corresponding to the perpendicular direction of the second engaging surface 321 is disposed at a position corresponding to the first combination hole 222, and a second clamping sheet 324 is disposed at the back of the second engaging portion 32.

The cover frame 4 is of straight shape and has a cover plate 41, the cover plate 41 approximately corresponds to a width of the opening 131 of the combination groove 13 and has a curvature corresponding to the outer circular surface 11 of the column 1, side plate portions 42 are disposed inwardly along a perpendicular direction on both sides of the cover plate 41 respectively, flanges 43 respectively engageable with the first catching groove 134 and the second catching groove 135 are disposed at ends of the two side plate portions 42.

When the present application is assembled, the first engaging portion 22 of the first hook body 2 may be combined with the external component 7 by inserting the engaging element 6 into the engaging hole 223, and a side of the external component 7 is attached against the first clamping sheet 224. Further, the first hook portion 21 of the first hook body 2 is inserted into the opening 131 of the combination groove 13 at appropriate angular position of the column 1 to enable the first hook edge 213 to hook the first catching groove 134; further, the second hook portion 31 of the second hook body 3 inserted into the opening 131 of the another adjacent combination groove 13 to enable the second hook edge 313 to hook the second catching groove 135. In this way, the first engaging surface 221 and the second engaging surface 321 are attached with each other. Further, the engaging elements 6 are inserted into the first combination hole 222 and the second combination hole 323 of the first engaging portion 22 and the second engaging portion 32 for combination. The buffer groove 322 of the second engaging portion 32 is provided, so that the first engaging surface 221 and the second engaging surface 321 can be abutted against each other more stably when engaging elements 6 are thread-tightened. in this case, the first hook edge 213 and the second hook edge 313 can more stably hook the first catching groove 134 and the second catching groove 135 respectively so as to more stably clamp the spacing portion 14 of the column 1. Further, the first side surface 212 and the second side surface 312 are more closely attached against the first side wall 132 and the second side wall 133 respectively. The abutting edge 214 of the first hook body 21 is closely attached against the outer circular surface 11 of the column 1, and the second clamping sheet 324 is attached against the other surface of the external component 7. In this way, the entire combination will have better combination stability without loosening. Further, in the present application, the first hook body 2 and the second hook body 3 may be directly inserted into the appropriate positions of the combination grooves 13 of the column 1 respectively for combination, without need of being inserted into the combination groove 13 from the end face 12 of the column 1 and then moved to appropriate positions of the combination grooves 13. Thus, better assembly convenience is achieved.

In the present application, the cover frame 4 may be inserted into the combination groove 13 of the column 1 from the end face 12 of the column 1 so that flanges on both sides of the cover frame 4 are embedded into the first catching groove 134 and the second catching groove 135 of the column 1 respectively. Thus, the cover frame 4 is prevented from radially falling from the column 1. In this case, the cover plate 14 covers the opening 131 of the combination groove 13. As a result, the openings 131 of the combination grooves 13 that are not assembled with the first hook body 2 and the second hook body 3 can be covered by the cover frames 4 so as to achieve better entire combination aesthetics.

The combination of several columns 1, several first hook bodies 2, several second hook bodies 3, and several sheet-shaped external components in the present application can be in a shape such as three-angle shape, four-angle shape, five-angle shape, grid shape or the like (not shown in Figures). Therefore, multiple assembly variations may be implemented.

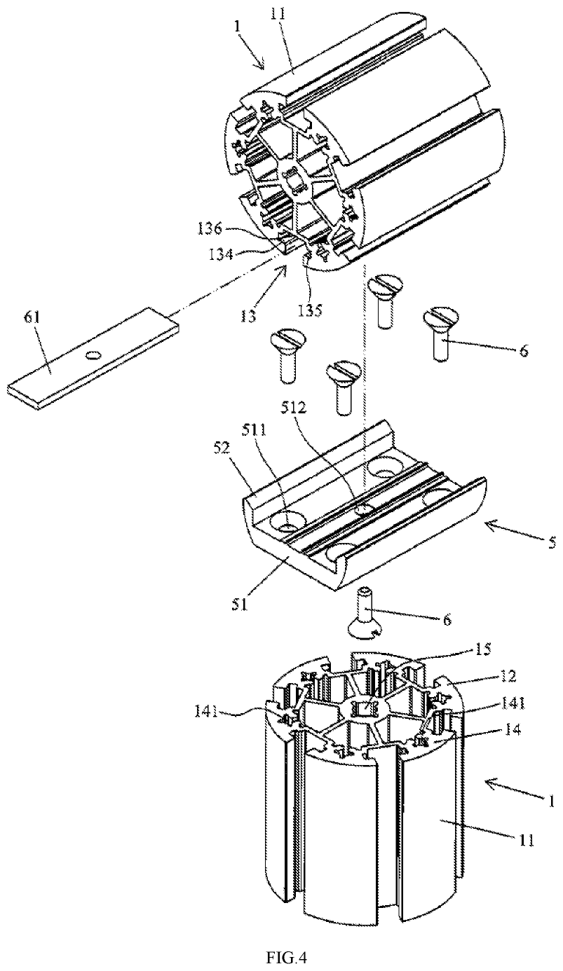

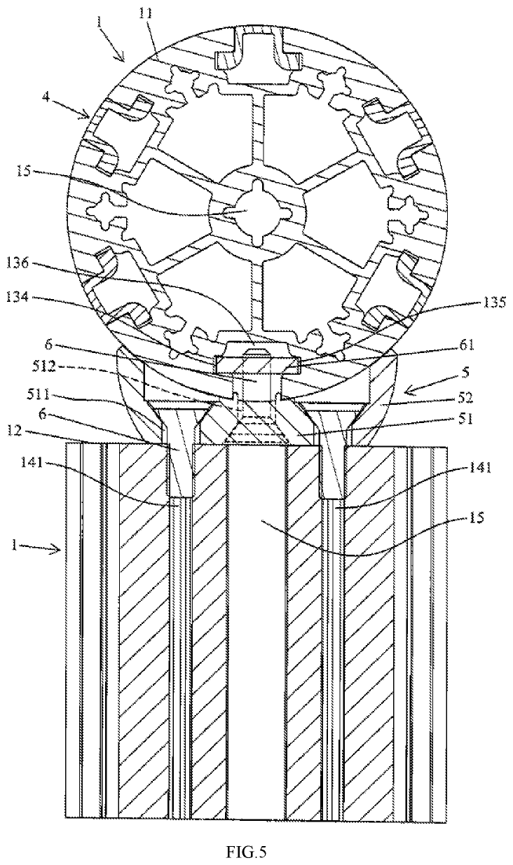

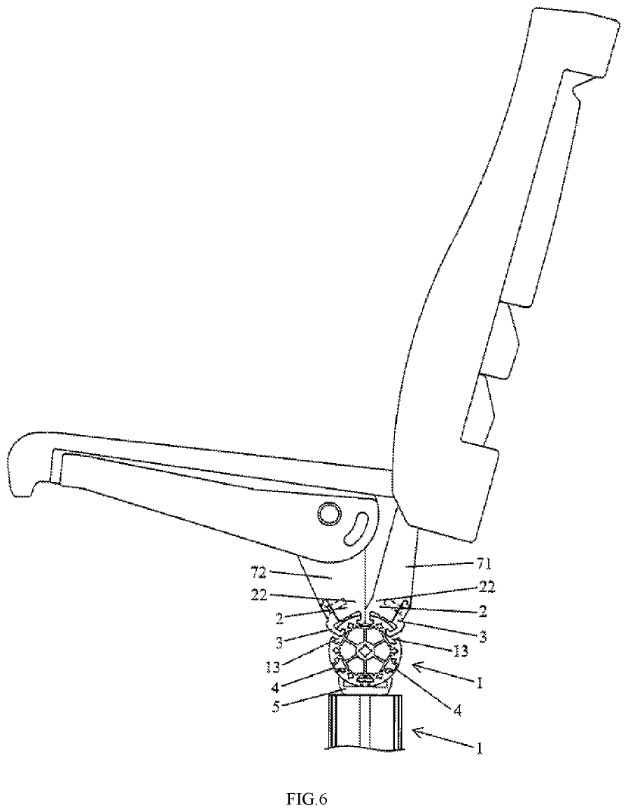

With reference to FIGS. 4-5, the present application further includes a connection block 5 having a connection plate 51. Side support plates 52 are disposed upwardly on both sides of the connection plate 51 respectively, the connection plate 51 may be disposed at the end face 12 of a column 1, first assembly holes 511 are disposed at positions corresponding to the combination hole 141 of the column 1, and a second assembly hole 512 is disposed at the center of the connection plate 51. The two side support plates 52 may be abutted against the outer circular surface 11 of another column 1. A assembly plate 61 is disposed at a position of a bottom combination groove 13 of the another column 1, both ends of the assembly plate 61 can be inserted into the first catching groove 134 and the second catching groove 135, the connection plate 51 of the connection block 5 may be placed on the end face 12 of a column 1 and combined with the combination hole 141 of the column 1 by inserting engaging elements 6 into the first assembly holes 511. Another column 1 may be placed on the connection block 51 to allow the side support plates 52 of the connection block 51 to be abutted against the outer circular surface 11 of the another column 1. Further, the engaging element 6 is inserted into the second assembly hole 512 to fixedly connect with the assembly plate 61 on the another column 1, the recess 136 of the combination groove 13 of the another column 1 may be provided so that an end of the engaging element 6 can be inserted, and the central through hole 15 of the column 1 may be provided to facilitate rotating the engaging element 6 by an inserting tool (not shown in Figures).

By referring to FIG. 6, the first engaging portion 22 of the first hook body 2 in the present application may be directly and integrally connected with an external component. For example, the first engaging portions 22 can be directly and integrally connected with a backrest support plate 71 and a seat support plate 72 of a seat respectively and assembled into the combination grooves 13 at appropriate angular positions of the column 1 respectively.

Thus, the column 1 of the present application may provide various external component combinations to achieve better application.

In conclusion, the present application has the effect of better assembly convenience and stability. Further, the preceding embodiments are merely illustrative of the present application rather than limit the present application. Any equivalent changes made based on the spirit of the present application all fall within the scope of protection of the present application.

Numerals of the drawings are described as follows:

1. column, 2. outer circular surface, 12 end face, 13. combination groove, 131. opening, 132. first side wall, 133. second side wall, 134. first catching groove, 135. second catching groove, 136. recess, 14. spacing portion, 141. combination hole, 15. through hole, 2. first hook body, 21. first hook portion, 211. first hook pillar, 212. first side surface, 213. first hook edge, 214. abutting edge, 22. first engaging portion, 221. first engaging surface, 222. first combination hole, 223. engaging hole, 224. first clamping sheet, 3. second hook body, 31. second hook portion, 311. second hook pillar, 312. second side surface, 313. second hook edge, 32. second engaging portion, 321. second engaging surface, 322. buffer groove, 323. second combination hole, 324. second clamping sheet, 4. cover frame, 41. cover plate, 42. side plate portion, 43. flange, 5. connection block, 51. connection plate, 511. first assembly hole, 512. second assembly hole, 52. side support plate, 6. engaging element, 61. assembly plate, 7. external component, 71. backrest support plate, 72. seat support plate.

What is claimed is:

1. A multi-directionally engageable column combination structure, comprising:
a column, being a straight shape and having an outer circular surface and two end faces, wherein a plurality of axial combination grooves inwardly recessed toward a center of the column at different angular positions of the outer circular surface, a spacing portion is disposed between adjacent combination grooves, an outer side of the combination groove has an opening corresponding to a radial direction of the column, the opening has opposite first and second side walls, first and second catching grooves along a circumferential direction are disposed at inner sides of the first and second side walls respectively, the first and second catching grooves are opposite in direction;
a first hook body, wherein a front end of the first hook body has a first hook portion, a rear end of the first hook portion has a first engaging portion, a front end of the first hook portion has a first hook pillar which is inserted into the opening of the combination groove, a first hook edge which is inserted into the first catching groove is disposed at a front end of the first hook pillar; a side of the first engaging portion has a first engaging surface, and a first combination hole corresponding to a perpendicular direction of the first engaging surface is disposed on the first engaging surface;
a second hook body, wherein a front end of the second hook body has a second hook portion, a rear end of the second hook portion has a second engaging portion, a front end of the second hook portion has a second hook pillar that is inserted into the opening of the combination groove, a second hook edge that is embedded into the second catching groove is disposed at a front end of the second hook pillar, a side of the second engaging portion has a second engaging surface attached against the first engaging surface, a second combination hole corresponding to a perpendicular direction of the second engaging surface is disposed at a position corresponding to the first combination hole, the first and second hook edges of the first and second hook bodies hook the first and second catching grooves respectively and then engaging elements are inserted into the first and second combination holes for combination.

2. The multi-directionally engageable column combination structure according to claim 1, wherein an inwardly recessed buffer groove is disposed in the second engaging surface.

3. The multi-directionally engageable column combination structure according to claim 1, wherein an abutting edge that is abutted against the outer circular surface is disposed at a position that is on the first hook body and corresponds to the outer circular surface of the column, the first hook pillar has a first side surface attached against the first side wall of the combination groove; the second hook pillar has a second side surface attached against the second side wall of the combination groove.

4. The multi-directionally engageable column combination structure according to claim 1, wherein the column is of cylindrical shape, the number of the combination grooves is six and adjacent combination grooves are spaced apart by 60°.

5. The multi-directionally engageable column combination structure according to claim 1, wherein a recess is disposed at an inner position of the first and second catching grooves of the combination groove.

6. The multi-directionally engageable column combination structure according to claim 1, wherein the column is in a cylindrical shape and has a plurality of cover frames, the cover frame is in a straight shape and has a cover plate, the cover plate approximately corresponds to a width of the opening of the combination groove and has a curvature corresponding to the outer circular surface of the column, side plate portions are disposed inwardly along a perpendicular direction on both sides of the cover plate respectively, flanges respectively engageable with the first catching groove and the second catching groove are disposed at ends of the two side plate portions.

7. The multi-directionally engageable column combination structure according to claim 1, wherein an axial combination hole is disposed at the spacing portion, and a through hole is disposed at the center of the column.

8. The multi-directionally engageable column combination structure according to claim 7, further comprising a connection block, wherein the connection block has a connection plate, side support plates are disposed upwardly at both sides of the connection plate respectively, the connection plate is placed on an end face of a column, a plurality of first assembly holes are disposed at positions corresponding to the combination holes of the column, and a second assembly hole is disposed at the center of the connection plate; the two side support plates are abutted against the outer circular surface of another column, an assembly plate is disposed at the position of the bottom combination groove of the another column, both ends of the assembly plate are embedded into the first and second catching grooves respectively, the connection plate of the connection block is combined by inserting engaging elements into the first assembly holes and the combination holes of the column, and engaging element is inserted into the second assembly hole to connect with the assembly plate on the another column.

9. The multi-directionally engageable column combination structure according to claim 1, an engaging hole engageable with an external component is disposed at the first engaging portion of the first hook body, and a first clamping sheet and a second clamping sheet for clamping the external component are disposed at rear ends of the first engaging portion and the second engaging portion respectively.

10. The multi-directionally engageable column combination structure according to claim 1, wherein the first hook body is integrally formed with the external component.
